(19) United States
(12) Patent Application Publication
(10) Pub. No.: US 2013/0221826 A1
(43) Pub. Date: Aug. 29, 2013

(54) PHOSPHOR-COATED LIGHT-EMITTING DEVICE

(71) Applicant: Fujio Okumura, Tokyo (JP)

(72) Inventor: Fujio Okumura, Tokyo (JP)

(73) Assignee: NEC Corporation, Minato-ku, Tokyo (JP)

(21) Appl. No.: 13/809,352

(22) PCT Filed: Jun. 15, 2011
(86) PCT No.: PCT/JP2011/063639

§ 371 Date: Mar. 25, 2013

(30) Foreign Application Priority Data
Sep. 21, 2010 (JP) 2010-211037

(51) Int. Cl. H05B 33/14

(52) U.S. Cl. CPC H05B 33/145
USPC 313/45; 313/512

(57) ABSTRACT

Provided is a phosphor-coated light-emitting device capable of satisfactorily cooling a phosphor with a simple structure. The phosphor-coated light-emitting device includes the phosphor for generating fluorescence by excitation light, and a phosphor bearing member for bearing the phosphor. The phosphor bearing member is formed into a flat-plate shape. In a region where the phosphor is formed, a vertical member having the same perpendicular line as that of the upper surface of the phosphor bearing member is formed.

### TECHNICAL FIELD

The present invention relates to a phosphor-coated light-emitting device that includes a phosphor for generating fluorescence when irradiated with excitation light.

### BACKGROUND ART

A technology using an LED (Light-Emitting Diode) as a light source for a projector such as a liquid crystal projector or a DMD (Digital Micromirror Device) projector for projecting an image on a screen has now become a focus of attention (Patent Literature 1).

Because of its long life and high reliability, the LED provides an advantage of a long life and high reliability of projectors that use the LED as a light source.

On the other hand, however, LED emitted light that is used for projectors is low in luminance and therefore, projectors that use LEDs as the light source cannot project videos that have sufficient luminance. The amount of light from the light source that can be used as projection light is limited by etendue. This means that unless the product value of the light-emitting area of the light source and the radiation angle is set equal to or less than that of the incident surface area of the display panel and the capturing angle determined by the F number of the illumination optical system, light from the light source cannot be efficiently used as projection light.

In the light source of the LED, the amount of light can be increased by increasing the light-emitting area. However, the increased light-emitting area leads to larger etendue of the light source. Because of the limitation imposed by the etendue, it is desirable to increase the amount of light without increasing the light-emitting area in the light source of the projector. However, it is difficult to increase the amount of light without increasing the light-emitting area in the light source of the LED.

Patent Literature 2 discloses a projector that includes a solid excitation light source for generating excitation light and phosphor layers for generating fluorescence of different wavelengths when irradiated with excitation light.

In view of the problems of the device disclosed in Patent Literature 2, namely, the reduction of wavelength conversion efficiency or performance deterioration over time caused by the temperature increase of the phosphor, which occurs because of the irradiation of similar portions of the phosphor layers with the excitation light, Patent Literature 3 discloses a light-emitting device that suppresses the temperature increase of the phosphor by moving the phosphor layers in order to change the irradiation position of the excitation light.

FIGS. 1A to 1C are sectional views showing the structure of the light-emitting device that changes the irradiation position of the excitation light by moving the phosphor layers disclosed in Patent Literature 3.

The device shown in FIG. 1A includes phosphor 603 formed into a doughnut shape on circular flat wheel plate 601 rotated around shaft 602. Phosphor 603 generates fluorescence 605 by the incidence of excitation laser beam 604. Generated fluorescence 605 is condensed by a not-shown condensing optical system to be used as illumination light. Phosphor 603 is disposed concentrically to wheel plate 601. The irradiation position of excitation laser beam 604 is changed by rotating wheel plate 601.

Each of FIGS. 1B and 1C shows the generated state of florescence 605 by irradiation with excitation laser beam 604. In an example shown in FIG. 1C, phosphor 603 is formed thicker than that in an example shown in FIG. 1B.

In the example shown in FIG. 1B, because fluorescence 603 is formed thin, excitation laser beam 604 cannot be totally absorbed. The part of the laser beam that is reflected becomes reflected light 606. Thus, fluorescence 605 includes unnecessary reflected light 606 as illumination light, causing color deterioration.

In the example shown in FIG. 1C, because fluorescence 603 is formed thick, no reflected light is generated. Heat generated by irradiation with excitation laser beam 604 is transmitted to wheel plate 601, and thus phosphor 603 is cooled. Wheel plate 601 is cooled by a cooling mechanism (not shown) to prevent temperature increase of phosphor 603.

As shown in FIG. 1B, when fluorescence 603 is formed thin, phosphor 603 is satisfactorily cooled. As shown in FIG. 1C, when fluorescence 603 is formed thick, phosphor 603 near wheel plate 601 is satisfactorily cooled. However, the portion of the phosphor near the upper surface of phosphor 603 irradiated with excitation laser beam 604 is not sufficiently cooled. Consequently, increases in temperature hasten deterioration.

The thickness of phosphor 603 may be set to about 5 to 10 microns to sufficiently cool phosphor 603, and about 200 to 300 microns may be set to sufficiently absorb excitation laser beam 604.

### CITATION LIST

Patent Literature 1: JP2003-186110A

Patent Literature 2: JP3967145B2

Patent Literature 3: JP2010-86815A

### SUMMARY OF INVENTION

### Problems to be Solved by Invention

In the light-emitting device that changes the irradiation position of the excitation light by moving the phosphor layers shown in FIGS. 1A to 1C, the excitation laser beam is scattered in the phosphor. Thus, the light-emitting area in the phosphor is larger than the spot size of the excitation laser beam applied to the phosphor.

The light source used for the projector is ideally a point light source, and the increased light-emitting area is a problem. To prevent the increase of the light-emitting area, the width of the phosphor formed into the doughnut shape may be reduced. In such a configuration, however, the irradiation position of the excitation laser beam must be accurately controlled. When the irradiation position of the excitation laser beam is shifted from the phosphor due to a temperature change or a shape change, there is a possibility that the laser beam may be reflected on the wheel plate.

In the light-emitting device shown in FIG. 1, the phosphor is easily cut because it is formed alone on the wheel plate.

Further, the light-emitting device is configured to cool the wheel plate. As a specific configuration to cool the wheel plate, a member that does not need to be used for the light source, such as a fan for blowing or a Pertier element for exchanging heat, needs to be used, thereby complicating the configuration. Especially, when the Pertier element is used, it must be attached to the rotating wheel plate, necessitating the use of a rotation driving mechanism of higher performance.

The present invention provides a phosphor-coated light-emitting device capable of satisfactorily cooling a phosphor with a simple structure.

### Solution to Problem

A phosphor-coated light-emitting device according to the present invention includes: a phosphor for generating fluorescence when irradiated with excitation light; and a phosphor bearing member for bearing the phosphor. The phosphor bearing member is formed into a flat-plate shape. In a region where the phosphor is formed, a vertical member having the same perpendicular line as that of the upper surface of the phosphor bearing member is formed.

### Effects of Invention

According to the present invention, the phosphor can be satisfactorily cooled with the simple structure.

According to the present invention, a laser beam of a high energy density is condensed as the excitation light on the phosphor, and fluorescence generated from the condensed place is used. Thus, an illumination optical system having small etendue, a long life, and high luminance can be provided.

### BRIEF DESCRIPTION OF DRAWINGS

[FIG. 1]

FIG. 1A is a sectional view showing the structure of a light-emitting device that changes the irradiation position of excitation light by moving a phosphor layer; and FIGS. 1B and 1C are views each showing the state of fluorescence 605 generated by irradiation with excitation laser beam 604.

[FIG. 2]

Views showing main components of a phosphor-coated light-emitting device according to the first embodiment of the present invention: FIG. 2A is a partial plan view; FIG. 2B is a sectional view cut along the line A-A′ shown in FIG. 2A; and FIG. 2C is a partial enlarged view of FIG. 2B.

[FIG. 3]

Views showing main components of a phosphor-coated light-emitting device according to the second embodiment of the present invention: FIG. 3A is a partial plan view; and FIG. 3B is a sectional view cut along the line B-B′ shown in FIG. 3A.

[FIG. 4]

A sectional view showing main components of a phosphor-coated light-emitting device according to the third embodiment of the present invention. [FIG. 5]

A sectional view showing main components of a phosphor-coated light-emitting device according to the fourth embodiment of the present invention.

[FIG. 6]

A plan view showing main components of a phosphor-coated light-emitting device according to the fifth embodiment of the present invention

### DESCRIPTION OF EMBODIMENT

Hereinafter, the embodiments of the present invention will be described with reference to the drawings.

FIGS. 2A to 2C are views showing the main components of a phosphor-coated light-emitting device according to the first embodiment of the present invention: FIG. 2A is a partial plan view; FIG. 2B is a sectional view cut along the line A-A′ shown in FIG. 2A; and FIG. 2C is a partial enlarged view of FIG. 2B.

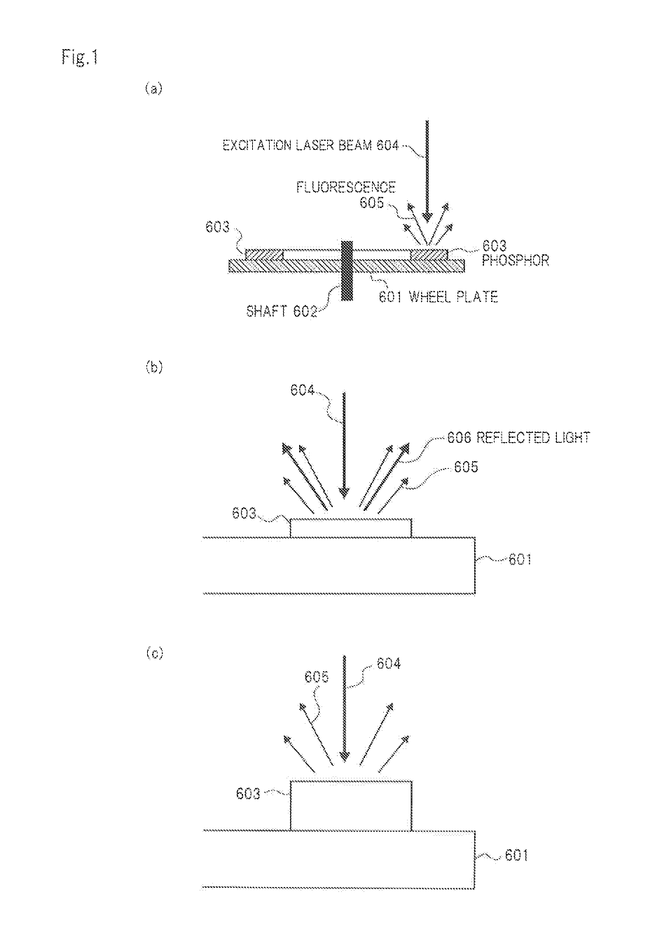

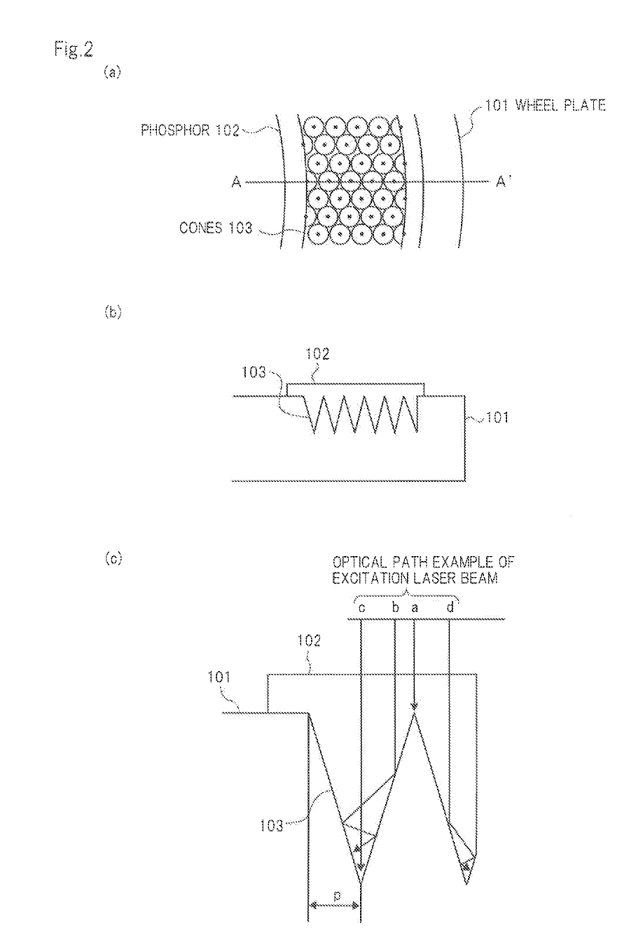

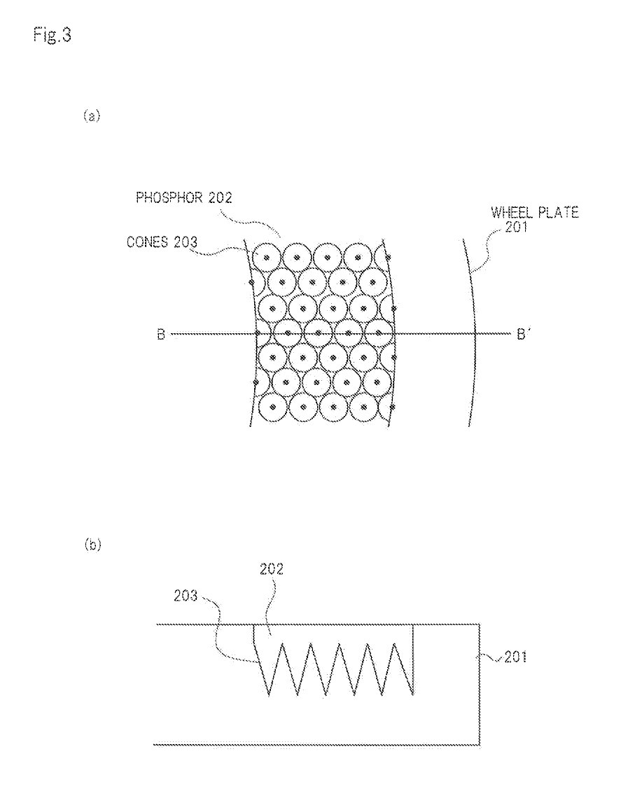

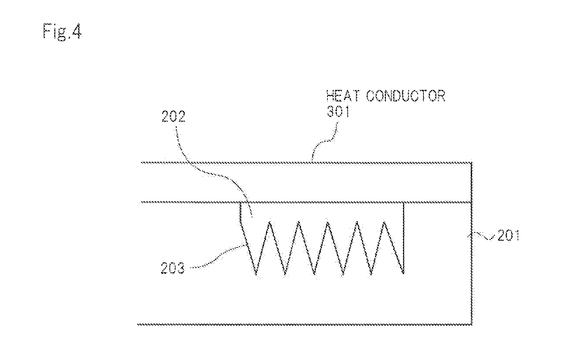

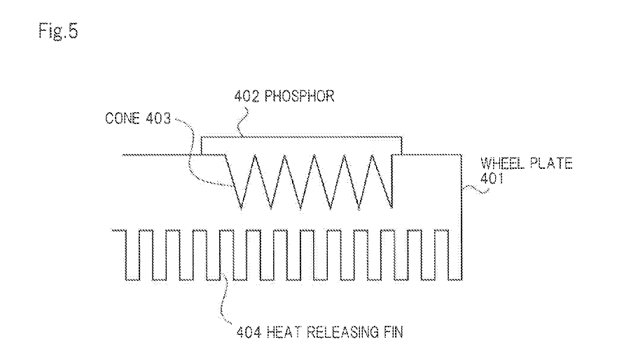

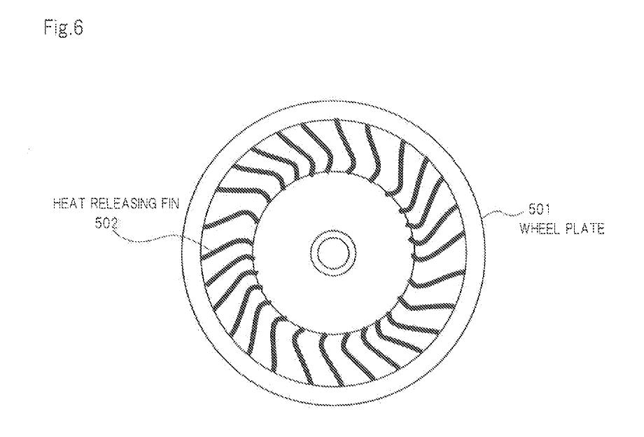

In this embodiment, as in the case of the light-emitting device shown in FIGS. 1A to 1C, phosphor 102 is formed into a doughnut shape on circular flat-plate wheel plate 101 rotated around an axis. In the place of wheel plate 101 where phosphor 102 is formed, a plurality of cones 13, which are conical projections, is formed with the upper surface side of wheel plate 101 set as a vertex, and phosphor 102 enters among cones 103.

An excitation laser beam enters phosphor 102 from the upper part of phosphor 102. Most of the excitation laser beam enters the side face of cone 103 indicated by incident optical paths b and d shown in FIG. 2C, is multiply reflected on the side face to be directed to the bottom surface of the cone, and absorbed by phosphor 102 during this process. The excitation laser beam incident on the bottom surface of the cone from an optical path c is also absorbed by phosphor 102 during the process of reaching the bottom surface. The excitation laser beam incident on the vertex of the optical cone from an optical path a is reflected. However, its rate is very small overall, and thus there is almost no influence.

In cooling of phosphor 102, the materials of wheel plate 101 and phosphor 102, the height of cone 103, and the radius p of the bottom surface are predominant factors. The configuration of this embodiment enables cooling while sufficiently absorbing light.

Cone 103 has been described to be conical. Needless to say, however, cone 103 can be pyramidal.

FIGS. 3A and 3B are views showing the main components of a phosphor-coated light-emitting device according to the second embodiment of the present invention: FIG. 3A is a partial plan view; and FIG. 3B is a sectional view cut along the line B-B′ shown in FIG. 3A.

In this embodiment, as in the aforementioned case, phosphor 202 is formed into a doughnut shape on circular flat-plate wheel plate 201 rotated around an axis. In the place of wheel plate 201 where phosphor 202 is formed, a plurality of cones 203, which are conical projections, enters spaces between cones 203.

In this embodiment, cone 203 has its vertex set inside wheel plate 201, and its location is lower than the upper surface of wheel plate 201. The upper surface of phosphor 202 is at the same position as that of the upper surface of wheel plate 201. Accordingly, phosphor 202 is buried in a groove including cone 203 formed in wheel plate 201, preventing cutting of phosphor 202. Further, the light-emitting area of phosphor 202 is regulated by the groove. In the direction of the line B-B′ shown in FIG. 3A, the width of the groove is not exceeded, and thus the light-emitting area can be stable.

FIG. 4 is a sectional view showing the main components of a phosphor-coated light-emitting device according to the third embodiment of the present invention.

In this embodiment, a flat-plate, transparent and heat-conductive heat conductor 301 is disposed on the upper surface of the phosphor-coated light-emitting device according to the second embodiment shown in FIGS. 3A and 3B. As a material for heat conductor 301, sapphire or SiC can be used.

The presence of heat conductor 301 enables the release heat even from the upper surface of phosphor 202. Thus, a higher cooling effect can be provided.

FIG. 5 is a sectional view showing the main components of a phosphor-coated light-emitting device according to the fourth embodiment of the present invention.

In this embodiment, wheel plate 401 includes heat releasing fin 404 formed in a surface opposite a surface where phosphor 402 is formed. Phosphor 402 and cone 403 are similar to phosphor 102 and cone 103 shown in FIGS. 2A to 2C.

Heat releasing fin 404 can be firmed in one surface of wheel plate 401 or only in a place corresponding to the forming region of phosphor 402.

Needless to say, heat releasing fin 404 can be disposed in the phosphor-coated light-emitting device according to the second embodiment shown in FIGS. 3A and 3B or the third embodiment shown in FIG. 4, which is within the present invention. The presence of heat releasing fin 404 can provide a higher cooling effect compared with the phosphor-coated light-emitting devices according to the aforementioned embodiments.

FIG. 6 is a plan view showing the main components of a phosphor-coated light-emitting device according to the fifth embodiment of the present invention

In this embodiment, as shown in FIG. 5, wheel plate 501 includes heat releasing fin 502 formed into a shape to function as a fan. FIG. 6 is a plan view seen from a side where heat releasing fin 502 is formed. Other components are similar to those of the embodiment shown in FIG. 5, and thus description thereof will be omitted.

In this embodiment, heat releasing fin 502 forms an air flow. Thus, a cooling effect can be higher than that of the phosphor-coated light-emitting device according to the fourth embodiment.

In each of the foregoing embodiments, the cone has been described on the assumption that the upper surface of the wheel is set as the vertex. Obviously, the reverse can provide the same effects, that is, the inside of the cone where the upper surface of the wheel plate is a bottom surface is void. A desirable shape of the cone is a vertical member where the incident direction of the excitation laser beam matches the perpendicular line of the cone. Accordingly, the cone in each embodiment is a vertical member where the upper surface of the wheel plate matches the perpendicular line of the cone. With this configuration, the excitation laser beam made perpendicularly incident on the upper surface of the wheel plate is efficiently absorbed, and the phosphor is sufficiently cooled.

Each embodiment has been described on the assumption that the phosphor is formed into the doughnut shape in the rotating wheel plate. This assumption takes into consideration cooling of the phosphor. As described above, since the phosphor is efficiently cooled, the phosphor bearing member does not need to move. Further, the phosphor bearing member can be formed into a circular arc shape in a part of the wheel plate. These forms are within the present invention.

### REFERENCE NUMERALS

101 Wheel plate
102 Phosphor
103 Cone
301 Heat conductor
404, 502 Heat releasing fin

What is claimed is:

1. A phosphor-coated light-emitting device comprising:
a phosphor for generating fluorescence by excitation light; and
a phosphor bearing member for bearing the phosphor,
wherein the phosphor bearing member is formed into a flat-plate shape, and in a region where the phosphor is formed, a vertical member having the same perpendicular line as that of an upper surface of the phosphor bearing member is formed.

2. The phosphor-coated light-emitting device according to claim 1, wherein an upper surface of the phosphor and the upper surface of the phosphor bearing member constitute the same plane.

3. The phosphor-coated light-emitting device according to claim 1, further comprising a transparent and heat conductive flat plate that covers the phosphor.

4. The phosphor-coated light-emitting device according to claim 2, further comprising a transparent and heat conductive flat plate that covers the phosphor.

5. The phosphor-coated light-emitting device according to claim 1, further comprising a heat releasing fin formed in a place corresponding to at least a region where the phosphor is formed on a rear surface of the phosphor bearing member where the phosphor is formed.

6. The phosphor-coated light-emitting device according to claim 2, further comprising a heat releasing fin formed in a place corresponding to at least a region where the phosphor is formed on a rear surface of the phosphor bearing member where the phosphor is formed

7. The phosphor-coated light-emitting device according to claim 3, further comprising a heat releasing fin formed in a place corresponding to at least a region where the phosphor is formed on a rear surface of the phosphor bearing member where the phosphor is formed.

8. The phosphor-coated light-emitting device according to claim 1, wherein the heat releasing fin is formed into a shape to function as a fan.

9. The phosphor-coated light-emitting device according to claim 2, wherein the heat releasing fin is formed into a shape to function as a fan.

10. The phosphor-coated light-emitting device according to claim 3, wherein the heat releasing fin is formed into a shape to function as a fan.

11. The phosphor-coated light-emitting device according to claim 4, wherein the heat releasing fin is formed into a shape to function as a fan.

12. The phosphor-coated light-emitting device according to claim 5, wherein the heat releasing fin is formed into a shape to function as a fan.

13. The phosphor-coated light-emitting device according to claim 6, wherein the heat releasing fin is formed into a shape to function as a fan.

14. The phosphor-coated light-emitting device according to claim 7, wherein the heat releasing fin is formed into a shape to function as a fan.

15. The phosphor-coated light-emitting device according to claim 1, wherein the phosphor bearing member is formed into a circular plate shape to rotate around a rotary shaft, and the region where the phosphor is formed is formed into a doughnut or circular arc shape on the phosphor bearing member around the rotary shaft.

16. The phosphor-coated light-emitting device according to claim 2, wherein the phosphor bearing member is formed into a circular plate shape to rotate around a rotary shaft, and the region where the phosphor is formed is formed into a doughnut or circular arc shape on the phosphor bearing member around the rotary shaft.

17. The phosphor-coated light-emitting device according to claim 3, wherein the phosphor bearing member is formed into a circular plate shape to rotate around a rotary shaft, and the region where the phosphor is formed is formed into a doughnut or circular arc shape on the phosphor bearing member around the rotary shaft.

18. The phosphor-coated light-emitting device according to claim 4, wherein the phosphor bearing member is formed into a circular plate shape to rotate around a rotary shaft, and the region where the phosphor is formed is formed into a doughnut or circular arc shape on the phosphor bearing member around the rotary shaft.

19. The phosphor-coated light-emitting device according to claim 5, wherein the phosphor bearing member is formed into a circular plate shape to rotate around a rotary shaft, and the region where the phosphor is formed is formed into a doughnut or circular arc shape on the phosphor bearing member around the rotary shaft.

20. The phosphor-coated light-emitting device according to claim 8, wherein the phosphor bearing member is formed into a circular plate shape to rotate around a rotary shaft, and the region where the phosphor is formed is formed into a doughnut or circular arc shape on the phosphor bearing member around the rotary shaft.
